(19) United States
(12) Patent Application Publication
(10) Pub. No.: US 2009/0295023 A1
(43) Pub. Date: Dec. 3, 2009

(54) INJECTION MOLDING METHOD AND MOLD FOR INJECTION MOLDING

(75) Inventor: Hiroaki Nagashima, Hamamatsu-shi (JP)

Correspondence Address: DARBY & DARBY P.C., P.O. BOX 770, Church Street Station, New York, NY, 10008-0770, US

(73) Assignee: Suzuki Motor Corporation, Hamamatsu-shi (JP)

(21) Appl. No.: 12/420,230

(22) Filed: Apr. 8, 2009

(30) Foreign Application Priority Data
May 27, 2008 (JP) 2008-138607

(51) Int. Cl. B29C 45/17; B29C 45/03

(52) U.S. Cl. 264/219; 425/542

(57) ABSTRACT

There is provided a mold for injection molding for manufacturing a resin injection-molded product. A provisional rib portion corresponding to a provisional rib which is to be formed to project from a portion, of the molded product, not serving as a design surface is formed at a predetermined position of a cavity so as to extend along the provisional rib, wherein resin is injected for molding to the provisional rib portion via a gate. The gate is formed as a submarine gate or a nose gate.

### CROSS-REFERENCE TO RELATED APPLICATIONS

This application is based upon and claims the benefit of priority of the prior Japanese Patent Application No. 2008-138607, filed on May 27, 2008, the entire contents of which are incorporated herein by reference.

### BACKGROUND OF THE INVENTION

1. Field of the Invention

The present invention relates to an injection molding method using resin or the like as a material and a mold for injection molding.

2. Description of the Related Art

In injection molding, for example, a side gate shown in FIG. 3 or an overlap gate shown in FIG. 4 is generally used as a gate of a mold in view of simplicity of machining of dies, securing of a charge amount of a resin material, and the like. Here, such molds will be roughly described. A mold 10 is composed of a die 11 (movable side or fixed side) and the other die 12 (fixed side or movable side), and a cavity 14 is formed by closing these dies 11, 12 along a parting line (dividing surface) 13. Molten resin flowing from a runner 15 is injected via a gate 16 (FIG. 3: side gate 16A, FIG. 4: overlap gate 16B) to fill the inside of the cavity 14.

In conventional molding, resin materials called solid colors not containing any luminous material have been mainstream materials. Therefore, even if the side gate or the overlap gate is used for injection molding, a defect in outer appearance does not occur from the gate part. In recent years, however, there is a demand for molding with resin materials containing a luminous material such as aluminum powder or mica powder and thus having metallic texture. As shown in FIG. 5A and FIG. 5B, when such resin materials are used, the resin materials flowing from both sides as depicted by the arrows collide with one another at a corner portion (gate corner portion), of a gate part (gate 16), which is in contact with a product or a molded product 100 (a design surface 100a thereof) when the product or the molded product 100 is formed, so that the molded product 100 bears, on its outer surface, black-streaks 1 called weld lines and thus is difficult to commercialize as it is.

In order to prevent the weld lines generated from the corner portion of a surface, of the gate part, which is in contact with the product, it is generally effective to employ what is called a submarine gate or the like having a circular gate cross section. However, though capable of preventing the generation of the weld lines, this gate shape has a problem of causing other defects in outer appearance such as meandering marks called jetting or silver-colored streaks called silver streaks.

These problems are ascribable to the structure of the die employing the submarine gate. Specifically, as shown in FIG. 6, the submarine gate is characterized in that the gate part (submarine gate 16C) is not disposed on a parting line 13 of the dies. Therefore, there is an undercut 12a in the die 12, and the product cannot be taken out in this state. In order to take out the product, the gate part has to be cut from the product. Therefore, when the submarine gate is employed, a product ejecting force from an ejector pin or the like is applied to automatically cut the gate part.

However, in the submarine gate, a surface, of the gate part, which is in contact with the product has to be extremely small, for example, about φ0.3 mm to about 1.2 mm in order for the gate part to be automatically cut. A great pressure shearing resin is applied on the surface, of the gate part, which is in contact with the product. This shearing of the resin is likely to cause the jetting and the silver streaks. Therefore, the use of the submarine gate for molding a design component has a problem that its material is limited to a resin material not easily sheared and its color is limited to color which does not make the jetting or the silver streaks, even if any, conspicuous.

Another method of preventing the generation of the weld lines is to round a gate corner portion of a side gate. However, since the side gate needs to be disposed on a parting line, this method has a problem that, in molding a component requiring the setting of the parting line on its design portion such as a design end portion, its design surface bears a trace of gate-cut.

As a method other than the measures relying on the gate shape, there is a measure relying on a material. For example, in the invention described in Japanese Patent Application Laid-open No. Hei 8-41284, the generation of weld lines is reduced by appropriate selection of the shape or grain size of a luminous material added to a resin material. Further, in the invention described in Japanese Patent Application Laid-open No. Hei 8-239505, the generation of weld lines is reduced by appropriate selection of a grain size and an addition amount of a luminous material and by the addition of titanium oxide, lead oxide, zinc oxide, or antimony oxide which is called a weld eraser. However, due to the restriction on the shape, grain size, addition amount, and the like of the luminous material, these measures can only limitedly produce texture such as shiny texture and metallic texture, resulting in a failure to produce a highly metallic color tone which is in high need as an alternative to the texture produced by painting or plating. Further, these measures are not capable of completely preventing the generation of the weld lines, and necessitate an increase in cost depending on a blending condition.

As described above, under conventional circumstances, it is difficult to make a molded product free of defect in outer appearance generated from the gate part, and there is no other choice but to employ painting or plating.

### SUMMARY OF THE INVENTION

In consideration of such circumstances, it is an object of the present invention to provide an injection molding method and a mold for injection molding guaranteeing excellent quality of outer appearance and effectively realizing cost reduction.

A mold for injection molding of the present invention is a mold for injection molding for manufacturing a resin injection-molded product, the mold including: a provisional rib portion corresponding to a provisional rib which is to be formed to project from a portion, of the molded product, not serving as a design surface, the provisional rib portion being formed at a predetermined position of a cavity so as to extend along the provisional rib, wherein resin is injected for molding to the provisional rib portion via a gate.

In the mold for injection molding of the present invention, the gate is formed as a submarine gate or a nose gate.

In the mold for injection molding of the present invention, a runner is disposed apart from a design surface of the molded product and extends along a parting line of the mold, an end portion of the design surface is set on the parting line, and the provisional rib portion is formed on an inner portion of a cavity surface extending along the parting line including the end portion.

In the mold for injection molding of the present invention, the provisional rib portion is disposed in an offset manner from the design surface toward an inner side of the cavity surface extending along the parting line.

An injection molding method of the present invention is an injection molding method for manufacturing a resin injection-molded product, the method including: forming a provisional rib portion corresponding to a provisional rib which is to be formed to project from a portion, of the molded product, not serving as a design surface, the provisional rib portion being formed at a predetermined position of a cavity so as to extend along the provisional rib; and injecting resin for molding to the provisional rib portion via a gate.

In the injection molding method of the present invention, a submarine gate or a nose gate is used as the gate.

### BRIEF DESCRIPTION OF THE DRAWINGS

FIG. 1 is a cross-sectional view showing the structure of a mold in an embodiment of the present invention;

FIG. 2 is a cross-sectional view showing the structure of a mold in a second embodiment of the present invention;

FIG. 3 is a cross-sectional view showing the structure of a mold having a side gate;

FIG. 4 is a cross-sectional view showing the structure of a mold having an overlap gate;

FIG. 5A and FIG. 5B are perspective views showing examples of the generation of weld lines in a mold having a side gate and in a mold having an overlap gate respectively; and

FIG. 6 is a view showing the structure of an essential part of a mold having a submarine gate.

### DETAILED DESCRIPTION OF THE PREFERRED EMBODIMENTS

Hereinafter, preferred embodiments of an injection molding method and a mold for injection molding according to the present invention will be described based on the drawings. In the description below, members which are substantially the same as or correspond to those of the prior art are denoted by the same reference numerals and symbols as those used in the prior art, and FIG. 3 to FIG. 6 are referred to when necessary.

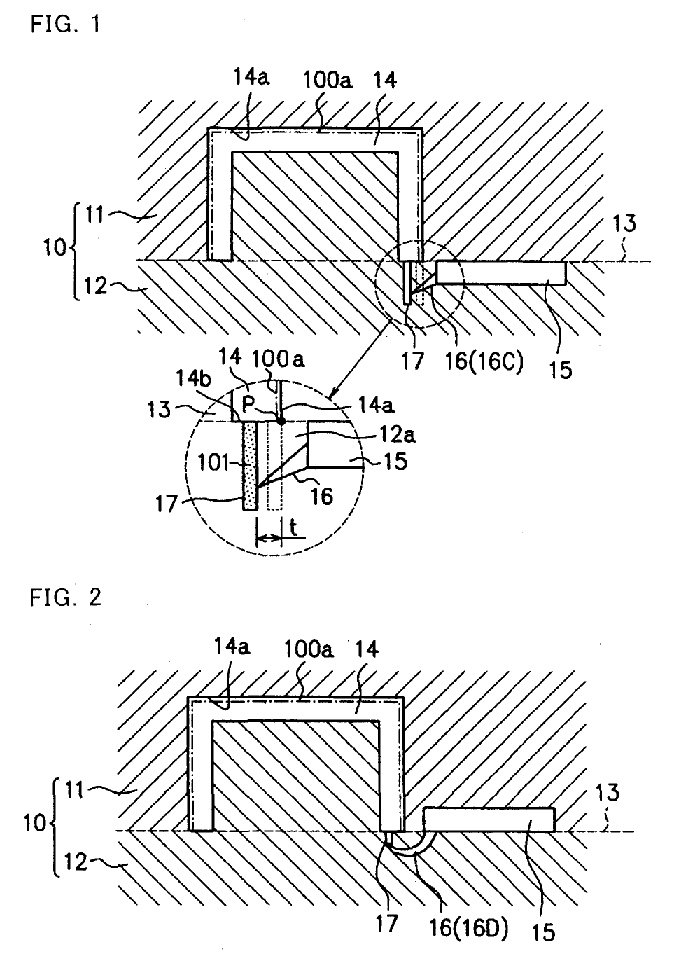

FIG. 1 shows a mold 10 in this embodiment. First, the mold 10 will be roughly described. The mold 10 is composed of a die 11 (movable side or fixed side) and the other die 12 (fixed side or movable side), and a cavity 14 is formed by closing the dies along a parting line (dividing surface) 13. Such a basic structure of the mold 10 may be substantially the same as that described in the prior art.

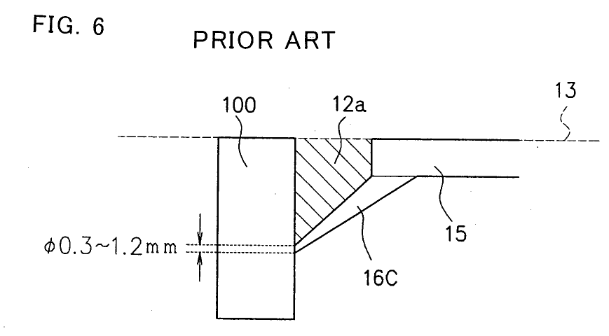

A runner 15 is disposed apart from a design surface 100a of a molded product 100 which is to be molded in the cavity 14, and extends along the parting line 13 of the mold 10. Molten resin flowing from the runner 15 is injected via a gate 16 (submarine gate 16C in this embodiment) to fill the inside of the cavity 14. As previously described, because the gate is the submarine gate, there is an undercut 12a in the die 12 as already shown in FIG. 6.

Here, regarding the shape and so on of the molded product 100, the molded product 100 is in, for example, a box shape having one side open, and the design surface 100a is set on an outer surface thereof. In this example, the design surface 100a has a U-shaped cross section. The cavity 14 has a cavity surface 14a corresponding to the design surface 100a. Therefore, by filling the molten resin in the cavity 14, followed by the injection molding, the design surface 100a exhibiting an outer appearance of the molded product 100 is formed in the cavity surface 14a.

Especially in the mold 10 of the present invention, a provisional rib 101 is formed to project from a portion, of the molded product 100, not serving as the design surface 100a at the time of the molding, and a provisional rib portion 17 corresponding to the provisional rib 101 is formed at a predetermined position of the cavity 14 so as to extend along the provisional rib 101. Then, the molten resin is injected for molding to the provisional rib portion 17 via the gate, that is, the submarine gate 16C. The provisional rib 101 is unnecessary as the product and thus is cut after the molding.

In the above case, the runner 15 is disposed apart from the design surface 100a of the molded product 100 and extends along the parting line 13 of the mold 10. Further, an end portion P of the design surface 100a (that is, a lower end portion of the cavity surface 14a in FIG. 1) is set on the parting line 13, and the provisional rib portion 17 is formed on an inner portion of a cavity surface 14b extending along the parting line 13 including the end portion P.

The provisional rib portion 17 is disposed in an offset manner from the design surface 100a toward an inner side of the cavity surface 14b extending along the parting line 13. That is, as shown in FIG. 1 (enlarged view), the provisional rib portion 17 is set in an offset manner from the design surface 100a—corresponding position, which is depicted by the dotted line, toward the inner side by t.

As described above, in the present invention, the provisional rib portion 17 is provided as shown in FIG. 1, and the molten resin is injected to the provisional rib portion 17 via the submarine gate 16C. In the molded product 100 thus molded, any of the sides of the provisional rib 101 does not overlap with the end portion P of the design surface 100a. If any one side of the provisional rib 101 overlaps with the end portion P of the design surface 100a, weld lines are generated on the design surface 100a.

According to the present invention, by providing the provisional rib portion 17 in the mold 10 and attaching the submarine gate 16C to the provisional rib portion 17, it is possible to prevent the generation of the weld lines starting from a corner of a surface, of the gate part, which is in contact with the product (molded product 100). Further, since the provisional rib 101 is disposed so as not to overlap with the end portion P of the design surface 100a, jetting and silver streaks that might appear when the submarine gate is employed basically appear in the provisional rib 101 itself, that is, they do not appear on the design surface 100a. This makes it possible to mold the molded product 100 with high-quality outer appearance.

Further, since the submarine gate 16C can be automatically cut when the mold is opened, only one cutting process of the provisional rib 101 is necessary, which means no increase in the number of processes since one cutting process is always necessary when a conventional side gate or overlap gate is employed. That is, cost reduction is practically realized while improved quality of outer appearance is realized.

Further, the present invention is applicable to a case where a resin material containing a luminous material such as aluminum powder or mica powder and thus having metallic texture is used, even though the use of such a resin material for mass production has been difficult due to the problem of a defect in outer appearance such as weld lines. Further, there is no restriction on the shape, grain size, addition amount of the luminous material, which makes it possible to effectively widen an applicable range of the present invention.

As an additional remark, due to a recent environmental problem, a reduction in an environmentally affecting substance such as a volatile organic compound also in automobile components has been taken up as an issue to be achieved. Further, also in resin components and the like, there has been a demand for a reduction in a volatile organic component which is produced at the time of painting, and there is an increasing need for using a molding material directly colored by a coloring agent such as a pigment and dye. Especially because of a recent increasing demand for components with improved texture such as metallic texture and shiny texture, there is a demand for molding with a molding material to which a luminous material such as aluminum powder or mica powder is added.

When a molding material to which any of these luminous materials is added is used, at the time of the injection molding with a gate having a rectangular gate surface, a defect in outer appearance such as weld lines ascribable to the orientation of the luminous material is likely to appear, starting from a gate corner portion, and hence such a luminous material is practically difficult to use. In the present invention, even when a molding material to which a luminous material is added is used, it is possible to effectively prevent the generation of the weld lines starting from the gate corner portion. This can widen the application of unpainted components. Further, the wide use of unpainted resin components or the like contributes to cost reduction of a molded product because a painting process is eliminated.

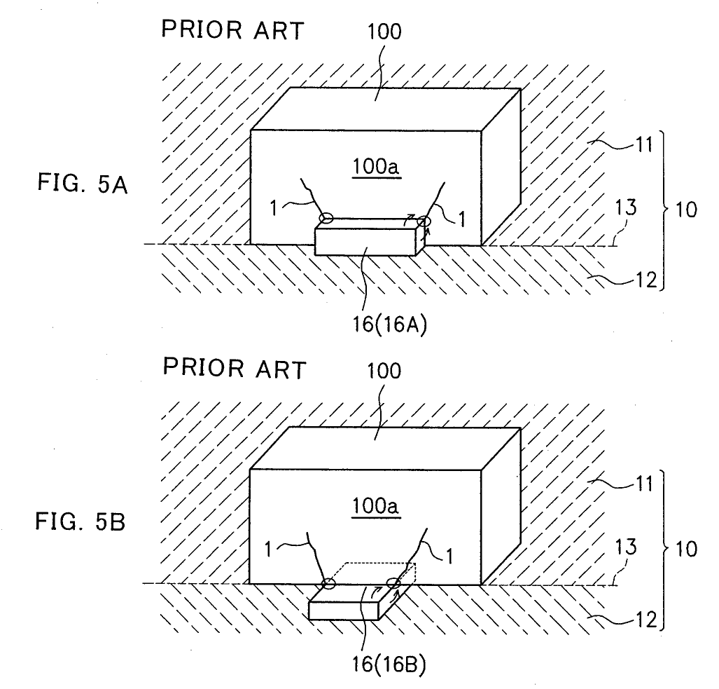

As previously described, the side gate shown in FIG. 3 or the overlap gate shown in FIG. 4 is disposed on the parting line since the gate and the runner are taken out when the mold is opened. With these gates, when the resin material to which aluminum powder, mica power, or the like is added is used for the molding, the weld lines are generated from the gate corner portion of the surface, of the gate, which is in contact with the product as shown in FIG. 5. Rounding the gate corner portion makes it possible to prevent the orientation of the luminous material, but as for a component on whose design surface end portion the parting line is set, the gate necessarily has to be disposed on the design surface side and therefore, the design surface bears a trace of gate-cut. Therefore, this method cannot be employed. Further, if the overlap gate is employed, the gate corner portion cannot be rounded due to the presence of the undercut, and there are issues to be achieved or problems as described previously in the prior art.

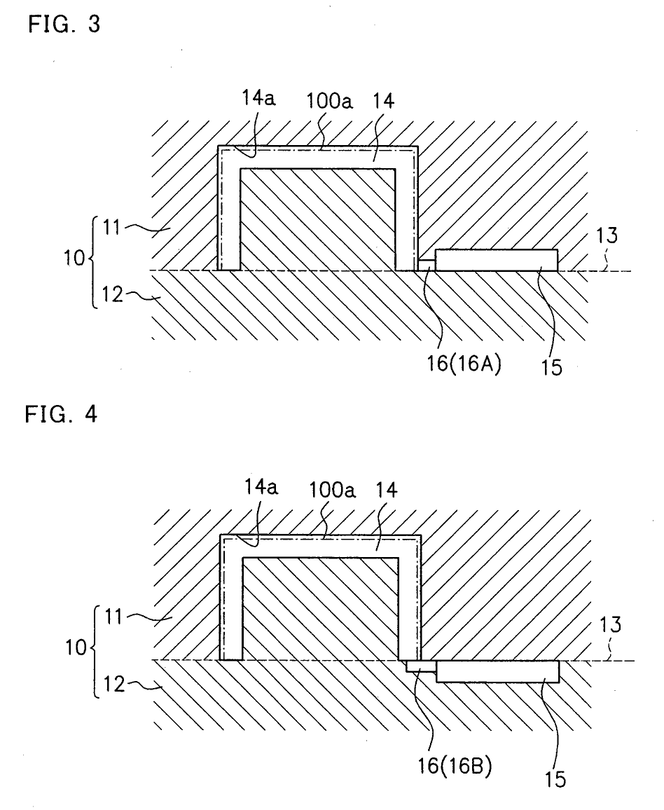

Next, FIG. 2 shows a second embodiment of the present invention. In the second embodiment, a gate 16 is formed as what is called a nose gate 16D. The other structure is substantially the same as that of the first embodiment.

In the second embodiment, as in the first embodiment, a provisional rib portion 17 is provided in a mold 10 and molten resin is injected to the provisional rib portion 17 via the nose gate 16D. Then, in a molded product 100, any of sides of a provisional rib 101 does not overlap with an end portion P of a design surface 100a, as in the above-described embodiment. The nose gate 16D extends from a runner 15 to the provisional rib portion 17 and communicates with a lower end portion of the provisional rib portion 17, as shown in FIG. 2.

In the second embodiment, the provisional rib portion 17 is provided in the mold 10, the nose gate 16D is attached to the provisional rib portion 17, and the provisional rib 101 does not overlap with the end portion P of the design surface 100a. Therefore, also in this embodiment, it is possible to prevent the generation of weld lines starting from a corner of a surface, of the gate part, which is in contact with the product and to prevent the generation of jetting and silver streaks.

According to the present invention, the provisional rib portion 17 is provided in the mold 10, and the resin is injected for molding to the provisional rib portion 17 via the submarine gate 16C or the nose gate 16D. Further, the provisional rib 101 is disposed so as not to overlap with the end portion P of the product design surface 100a, which makes it possible to prevent the generation of weld lines starting from the corner of the surface, of the gate part, which is in contact with the product, and to prevent the generation of jetting and silver streaks. Therefore, the molding of a molded product having high-quality outer appearance is enabled.

Further, since the gate can be automatically cut when the mold is opened, there is substantially no increase in the number of processes such as a cutting process. That is, cost reduction is practically realized while improved quality of the outer appearance is realized. Further, the present invention is applicable to a case where a resin material containing a luminous material such as aluminum powder or mica powder and thus having high metallic texture is used, and in addition, there is no restriction on the shape, grain size, and addition amount of the luminous material, which makes it possible to effectively widen an applicable range of the present invention.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

For example, the shape and so on of the molded product 100 are not limited to those in the shown example, and the present invention is effectively applicable to other shapes and so on, and is capable of providing the same operations and effects as those of the above-described embodiments.

What is claimed is:

1. A mold for injection molding for manufacturing a resin injection-molded product, the mold comprising:
a provisional rib portion corresponding to a provisional rib which is to be formed to project from a portion, of the molded product, not serving as a design surface, said provisional rib portion being formed at a predetermined position of a cavity so as to extend along the provisional rib, wherein
resin is injected for molding to said provisional rib portion via a gate.

2. The mold for injection molding according to claim 1, wherein the gate is formed as a submarine gate or a nose gate.

3. The mold for injection molding according to claim 1, wherein a runner is disposed apart from a design surface of the molded product and extends along a parting line of the mold, an end portion of the design surface is set on the parting line, and said provisional rib portion is formed on an inner portion of a cavity surface extending along the parting line including the end portion.

4. The mold for injection molding according to claim 2, wherein
a runner is disposed apart from a design surface of the molded product and extends along a parting line of the mold, an end portion of the design surface is set on the parting line, and said provisional rib portion is formed on an inner portion of a cavity surface extending along the parting line including the end portion.

5. The mold for injection molding according to claim 3, wherein said provisional rib portion is disposed in an offset manner from the design surface toward an inner side of the cavity surface extending along the parting line.

6. The mold for injection molding according to claim 4, wherein said provisional rib portion is disposed in an offset manner from the design surface toward an inner side of the cavity surface extending along the parting line.

7. An injection molding method for manufacturing a resin injection-molded product, the method comprising:
forming a provisional rib portion corresponding to a provisional rib which is to be formed to project from a portion, of the molded product, not serving as a design surface, the provisional rib portion being formed at a predetermined position of a cavity so as to extend along the provisional rib; and
injecting resin for molding to the provisional rib portion via a gate.

8. The injection molding method according to claim 7, wherein a submarine gate or a nose gate is used as the gate.
